(19) United States
(12) Patent Application Publication
(10) Pub. No.: US 2025/0074494 A1
(43) Pub. Date: Mar. 6, 2025

(54) WHEELED CHILD CARRIER WITH PET BASKET

(71) Applicant: Evenflo Company, Inc., Miamisburg, OH (US)

(72) Inventors: Dorothy CHIN GERDING, Smithfield, RI (US); Jeremy CROSSGROVE, Revere, MA (US); Michelle M.J. WOOD, Rehoboth, MA (US)

(73) Assignee: Evenflo Company, Inc., Miamisburg, OH (US)

(21) Appl. No.: 18/240,121

(22) Filed: Aug. 30, 2023

(51) Int. Cl. B62B 7/06; B62B 9/26

(52) U.S. Cl. CPC B62B 7/062; B62B 9/26; B62B 9/142; B62B 2202/42

(57) ABSTRACT

A wheeled child carrier, such as a stroller, basket, and components thereof that provide improved capabilities for housing a pet is provided. The basket includes a ramp that, in a closed position, forms part of a side of the basket. The ramp may be rotatably connected to a movable front structure of the basket. The ramp can be securely locked into place in the closed position while the pet is being held in the basket. The ramp can be unlocked and moved into an open position, with one end of the ramp touching or being adjacent to the ground. The locking mechanism for the ramp can be configured to allow for easy unlocking by a human user but difficult for the pet to unlock on its own.

### BACKGROUND

Transporting young children and pets at the same time in a safe and secure manner while walking from one location to another can be difficult. A wheeled child carrier, such as a stroller, equipped with a basket (or other container or holder) capable of holding a pet can greatly assist in this task, but having to pick up the pet to put them into the stroller basket may be difficult for some individuals, particularly if the pet is heavy or acting in an uncooperative manner or if a child requires attention. Additionally, many strollers with baskets underneath the child seat of the stroller are not intended to be used for pets and have very little space or clearance between the top of the basket and the bottom of the child seat. Furthermore, the top lip of a stroller basket may be a significant distance above the ground. This makes it difficult for a pet, even if they were otherwise capable of doing so, of being able to get into the basket on its own.

### SUMMARY

This disclosure is related to a wheeled child carrier, such as a stroller or wagon, basket, and components thereof that provide improved capabilities for housing a pet. For example, some aspects of the disclosure provide improved access to the basket, compared to traditional strollers with baskets, by having a basket with a ramp that, in a closed position, forms part of a side of the basket. The ramp can be securely locked into place in the closed position while the pet is being held in the basket. The ramp can be unlocked and moved into an open position, with one end of the ramp touching or being adjacent to the ground. In this way, the ramp forms a bridge or connection between the ground to the bottom of the basket, allowing the pet, on its own, to easily enter and exit the interior of the basket. The locking mechanism for the ramp can be configured to allow for easy unlocking by a human user but difficult for the pet to unlock on its own. The basket may be configured to meet relevant standards for pet usage while also be usable for other purposes, such as storing childcare products.

In some embodiments, the basket can also be resized to better accommodate the size of a particular animal while also not impeding the other functionality of the wheeled child carrier, including its ability to fold closed into a more compact configuration when not in use. This resizing may be accomplished via several different mechanisms that can be implemented separately or in combination with each other. In some embodiments, the basket may include a front frame structure that can move between multiple positions to change the overall size and volume of the basket. The front frame structure is configured to be compatible with the ramp mechanism described above. In other embodiments, the basket is equipped with a cover that can also act a divider to partition the basket cavity into two smaller sections. In this way, the basket can be used for both housing a pet and storing other items in separate areas. Additionally, the cover may be configured to removably cover the top of at least part of the basket to provide an enclosed section or interior for a portion of the basket, which keeps the pet contained within the basket without a risk of the pet jumping out. When not in use, the cover, which may be either partially, or fully detachable from the basket, can be securely stored away.

These and other aspects of the present invention are described further below with reference to the accompanying drawings.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numbers designate corresponding parts throughout different views.

FIG. 1 is a perspective view of a stroller with a basket in accordance with a first embodiment of the present invention.

FIG. 2 is a perspective view of the lower section of the stroller shown in FIG. 1 with the basket shell removed, with front frame structure in its open configuration and the ramp in its closed configuration.

FIG. 3 is a different perspective cutaway view of the front frame structure and ramp of the basket shown in FIG. 1.

FIG. 4 is a magnified view of a part of the ramp and front frame structure shown in FIG. 3.

FIG. 5 is a perspective view of the lower section of the stroller shown in FIG. 1 with the front frame structure in its open position and the ramp in its open position.

FIGS. 6A and 6B are side views of the basket shown in FIG. 1 with the front frame structure in its open and closed positions, respectively.

FIG. 7 is a perspective view of the stroller shown in FIG. 1 in its folded configuration.

FIG. 8 is a close-up top view of the basket shown in FIG. 1 with the cover in a deployed and attached position.

FIG. 9 is a perspective view of the basket and cover shown in FIG. 8.

FIG. 10 is a top view of the basket shown in FIG. 1 with the cover in a rolled and secured position.

FIG. 11 depicts a block diagram of a method of manufacturing a basket in accordance with embodiments of the present disclosure.

### DETAILED DESCRIPTION

In general, described herein are baskets and wheeled child carriers with a basket suitable for securing and transporting pets, and methods of manufacturing and using the same, among other things. The wheeled child carriers and baskets described herein allow pets easier access into and out of the basket while also providing a secure enclosure in which the pet can be safely transported while the wheeled child carrier is in motion.

In an embodiment, a wheeled child carrier with a basket is provided. The wheeled child carrier may be a stroller and can include at least an upper structure with a handlebar and upper arms that connect to a lower structure, which may include a pair of front legs and back legs. The upper arms may connect to and support a child seat. The basket is connected to the lower structure of the wheeled child carrier and positioned under the child seat. Rotatable hinges can connect the various wheeled child carrier components to allow the wheeled child carrier to be folded into a more compact form when not in use.

The basket is supported by the front legs and the back legs. In an embodiment, the frame of the basket is formed from a U-shaped front frame structure, a ramp rotatably attached to the front frame structure, and a side tube. The basket frame is covered with a fabric shell or covering that forms the side panels, the back panel and the bottom panel of the basket, with the ramp and front frame structure forming the front panel of the basket when the ramp is in its closed position. In an embodiment, one or more additional rigid structures form at least part of the basket frame and are contained within or connected to the fabric covering.

The front of the basket is formed by the front frame structure and the ramp. The ramp is rotatable between a closed position and an open position relative to the front frame structure, and can be configured with components that allow the ramp to be increased and decreased in length. When in a closed position, the ramp, together with the front frame structure, forms part of the sides of the basket that define the interior of the basket. In an open position, the ramp forms a bridge between the ground and the bottom of the basket while an opening in the front of the basket appears in the space that the ramp is rotated out of, allowing a pet to easily move, on its own, in and out of the interior of the basket. The user can then rotate the ramp back into its closed position.

The ramp can have a locking mechanism to keep the ramp securely in its closed position when the pet is being transported in the interior of the basket. In an embodiment, the locking mechanism can be disengaged or unlocked when the ramp is lengthened and engaged or locked when the ramp is shortened.

In embodiments, the front frame structure of the basket can also be rotatably connected to the lower structure of the wheeled child carrier. This can facilitate the folding and unfolding of the wheeled child carrier from its open use configuration to its folded storage configuration. The rotatable frame structure can also be configured so that the dimensions and interior volume of the basket can be changed. The side panels, which can be connected to the sides of the front frame structure, and the bottom panel, which can be attached to the bottom of the front frame structure, can be configured to accommodate these changes in orientation or dimension.

In another aspect of the invention, a basket with a multipurpose cover is provided. The basket has a plurality of side panels connected to each other and to a bottom panel, which together form a cavity. A cover has a first end is attached to the top (i.e. inward facing) surface of the bottom panel and can have a second end attached to a the front edge of the front panel of the basket, with the edges of the cover connected along the top edge of the side panels before running down the inner surface of the side panels. The edges of the cover can be selectively attached or detached from the top edges or inner surfaces of the panels, allowing for multiple configurations to be realized. When the cover runs along the inner surface, it serves to divide the basket cavity into a front section and a back section. One or more zippers or other connectors may be used to connect each side edge of the cover to the different parts of the basket panels. Magnets, hook and elastic connectors, or other suitable fasteners may also be used to secure the ends of the cover to the front panel. The cover may be comprised of a flexible material that may offer other benefits such as waterproofing or ventilation.

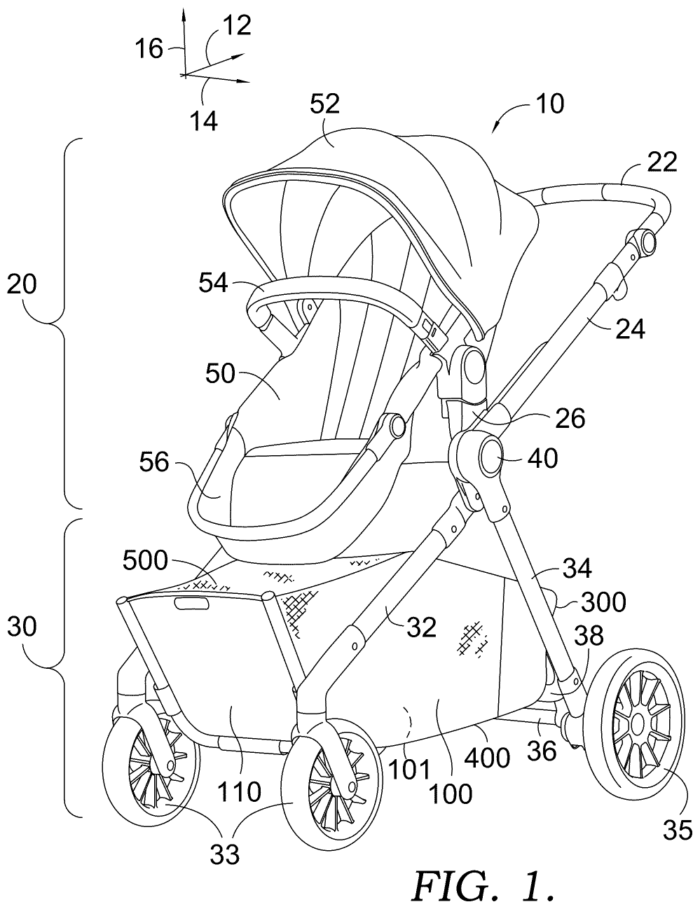

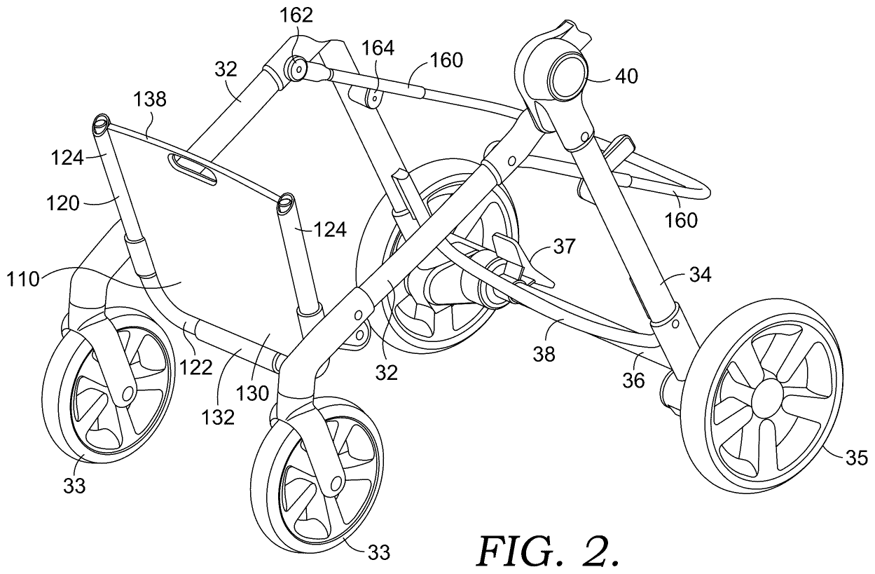

With reference now to FIG. 1, a wheeled child carrier, specifically a stroller 10, has an upper structure 20 including a handlebar 22 and upper arms 24. The upper arms 24 connect to the stroller's lower structure 30, via hinges 40, which includes front legs 32 and back legs 34. At the end of each front leg 32 is a front wheel 33. The front wheels 33 may be attached via a caster, allowing the front wheels 33 to change their orientation around a vertical axis when the stroller 10 is steered to one direction or the other. At the end of each back leg 34 is a back wheel 35, which may have a fixed orientation, with an axle 36 connecting the two wheels 35 together. The back legs 34 are further connected by a crossbar 38 to provide additional structural stability. As shown in FIG. 2, the axle 36 may include a brake 37 to releasably lock back wheels 35 in order prevent the stroller 10 from moving inadvertently, particularly while the pet is moving in or out of the basket as further described below.

The upper arms 24 include connection points 26 for attaching and supporting a seat 50 between them. The seat 50 may include a foldable canopy 52, a handlebar or armrest 54, a footrest 56, and/or a seat belt or harness (not shown).

It is to be understood by one of skill in the art that the present invention may be suitable for use with many different types of wheeled child carriers, including different types of strollers, which may have some differences with respect to specific features than those depicted and described herein. For example, additional accessories (e.g., cupholders, pockets, etc.) may also be included on the carrier body or seat without interfering with the present invention. Furthermore, while the stroller shown in FIG. 1 shows the seat being oriented to face towards the front of the stroller, it is to be appreciated that the present invention may also readily be used with strollers where the seat is facing toward the back of the stroller, or a stroller having a bassinet that holds an infant in a lying position instead of a seat holding a child in a more upright seated position. Additionally, although the stroller 10 includes two front legs 32, aspects of this disclosure may apply to strollers with a single front leg, such as jogger strollers. Aspects of the disclosure may also be applies to strollers without hinges or otherwise not capable of folding upper arms towards a lower structure of the stroller. The present invention may also be used with other types of wheeled child carrier, such as wagons, or other movable apparatuses with enclosures, such as handcarts or trolleys, where it is desirable to provide a way a pet to more easily enter and exit on its own.

Looking at FIG. 1, from a reference standpoint, the stroller 10 has a longitudinal axis 12, a transverse or lateral axis 14, and a vertical axis 16. In the embodiment shown in FIG. 1, the “front” of the stroller refers to the end of the stroller opposite the handlebar, and the “back” of the stroller refers to the end of the stroller that the handlebar extends from. However, it should be understood that unless otherwise indicated, the designations of “front” and “back”, particularly with respect to panels and basket structures, may be interpreted to be on either side of the longitudinal axis 12. The “upper” section of the stroller refers to the parts of the stroller above a midpoint, such as the hinge 40, that are further away from the ground when the stroller is in its open configuration with its wheels on the ground, with the “lower” section of the stroller referring to the parts below the midpoint (e.g., the hinge 40) that are closer to the ground. “Longitudinal axis” as referred to herein is the direction extending generally between the front of the stroller and the back of the stroller, or rather, along a direction that the stroller is typically pushed along when moving in a straight line. “Transverse axis” as referred to herein is the direction extending generally between the sides of the stroller, or rather a direction substantially perpendicular to the longitudinal axis and parallel to the ground. As used herein, “length” refers to a linear measurement generally along the longitudinal axis 12, “width” refers to a linear measurement generally along the transverse axis 14, and “height” or “depth” refers to a linear measurement generally along the vertical axis 16.

In this example, the basket 100 is located under the seat 50 and in between the front legs 32 and back legs 34 of the stroller 10. The basket 100 has a front 110, side panels 200, a back panel 300, and a bottom panel 400, that collectively define an inner cavity or volume 101 of the basket 100. The basket 100 may also include a cover 500; various embodiments of a cover in accordance with embodiments of the present invention will be described in further detail herein. In other examples, the term “basket” may refer to other enclosures on a wheeled child carrier, including a wagon enclosure suitable for containing a child for transportation.

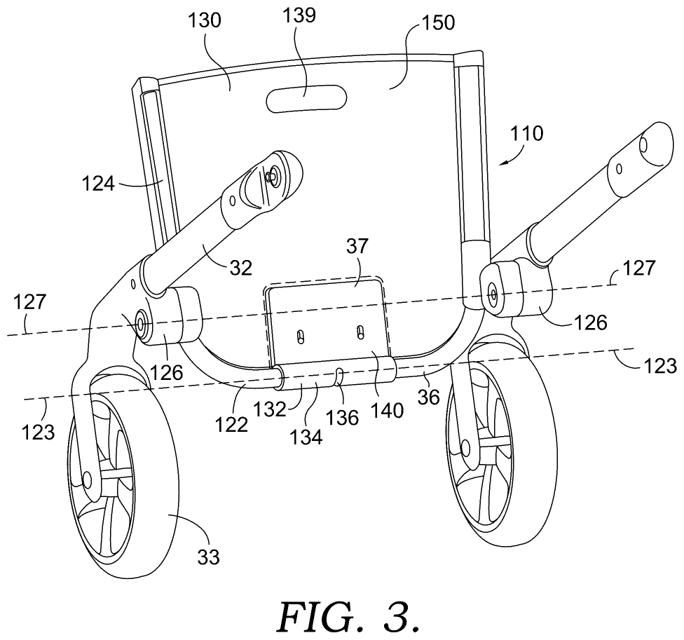

The front 110 of the basket 100 includes a front frame structure 120. Looking again at FIG. 1 and also at FIGS. 2 and 3, the front frame structure 120 is U-shaped and includes a crossbar 122 and two struts 124. As shown in FIG. 3, the front frame structure 120 may be formed of a single piece of material. In other alternative embodiments the crossbar and strut may comprise separate components that are joined together. Further, other examples of the front frame structure 120 include side edges or portions of rigid side panels.

Embodiments of the basket 100 further include a ramp 130 that is configured to rotate about a portion of the front frame structure 120 to move from an open position to a closed positon. The ramp 130 has a substantially rigid body capable of supporting weight, such as weight of a pet. In an aspect, the various components of the basket, including the ramp 130, are designed to be weight rated to at least 45 lbs (20.41 kg). The ramp 130 extends from a first end 132 of the ramp 130 to a second end 138. The first end 132 of the ramp 130 is pivotally coupled to the front frame structure 120, such as a bottom portion of the front frame structure 120. In some aspects, the coupling mechanism between the ramp 130 and the front frame structure 120 limits, such as via stop, the degree of rotation between the ramp 130 and the front frame structure 120.

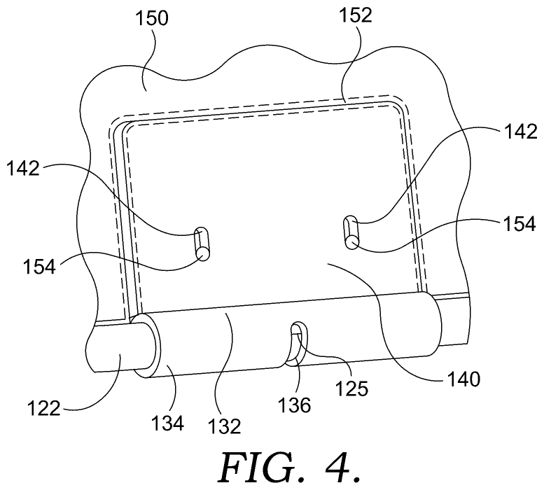

One embodiment of the coupling mechanism between the ramp 130 and the front frame structure 120 is shown in greater detail in FIGS. 3 and 4. In an embodiment, the first end 132 of the ramp 130 comprises a hollow tube or sleeve 134 that encircles the crossbar 122 of the front frame structure 120. As shown in FIG. 3, the sleeve 134 has a slot 136 around a portion of the circumference of the sleeve 134 that interacts with a stop 125 in the crossbar 122 to limit and define the amount of rotation between the crossbar 122 and the ramp 130 and the resultant positions that the front frame structure 120 and the ramp 130 can take in relation to each other.

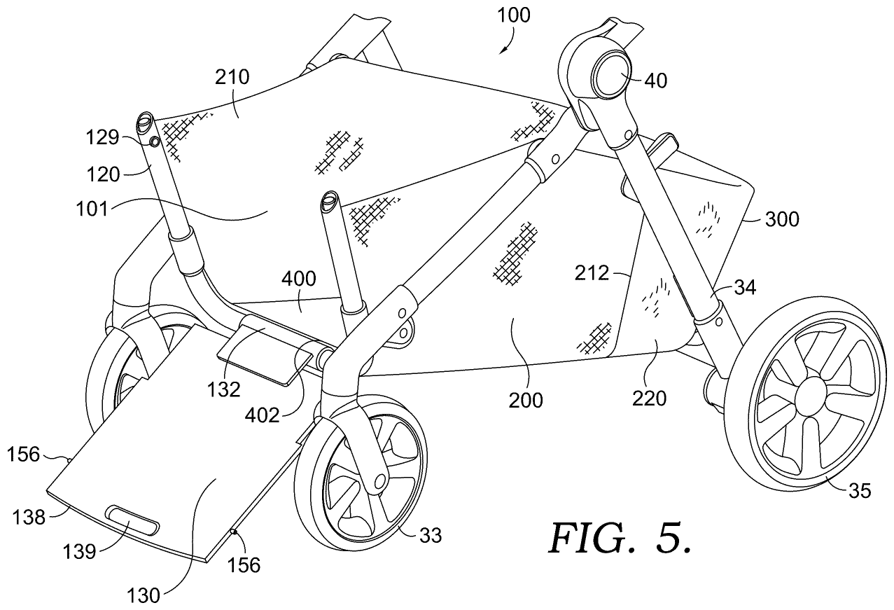

The second end 138 of the ramp 130, in a closed configuration as shown in FIG. 2, defines the top edge of the front 110 of the basket 100. When the ramp 130 is rotated relative to the front frame structure 120 into an open position, as shown in FIG. 5, the second end 138 touches or is adjacent to the ground, allowing a pet easy access to enter or exit the inner cavity 101 of the basket 100. In an embodiment, the ramp is made of rigid material such as metal, plastic and/or compressed wood board. Portions or the entirety of the surface of the ramp 130 may be textured, or may have a coating added to it to aid in traction make it easier for the pet to walk or move on without slipping. The ramp 130 may have perforations (openings) that reduce weight, improve ventilation, and/or allow visibility into or out from the basket.

Looking now at FIGS. 3 to 5, the ramp 130 may be composed of two connected pieces that are slidable in relation to each other. As shown in FIGS. 3 and 4, the first ramp portion 140 includes the first end 132 of the ramp that is connected to the front frame structure 120 (such as at the crossbar 122), with the second ramp portion 150 forming the majority of the body of the ramp 130 including the second end 138. The first ramp portion 140 and the second ramp portion 130 may be slidably connected such that one portion traverses relative to the other. In the example depicted in FIGS. 3 and 4, the body of the first ramp portion 140 is nestled in a slot 152 formed in the edge of second ramp portion 150. Slots 142 in the first portion 140 of the ramp 130 interface with stops 154 in the second ramp portion 150 (which may be in the form of screws that are fastened into and through the second ramp portion 150) to guide the sliding direction of the first ramp portion 140 and the second ramp portion 150 with respect to each other and to limit and define the amount of lateral or sliding movement between them, e.g., the ramp 130 reaches its fully extended length when the stops 154 are at the ends of the slots 142 furthest away from the crossbar 112. As shown in FIG. 5, when the ramp 130 is in its open position, the second end 138 of the ramp 130 may touch or be adjacent to the ground, allowing a pet to easily walk up or down the ramp 130 and into or out of the basket cavity 101.

In the embodiment shown in FIGS. 1-3, the sliding of the ramp elements (the first ramp portion 140 and the second ramp portion 150) in relation to each other also causes the ramp 130 to be locked or unlocked from its closed position. As shown in FIG. 5, tabs 156 extend out from the sides of the second ramp portion 150. In the ramp's closed position, these tabs are engaged with slots 129 in the struts 124, preventing the ramp 130 from rotating out of its closed position. When a user extends the ramp 130 by pulling the handle 139, the tabs 156 are slid out of the slots 129, allowing the ramp 130 to now be rotated towards its open position. In an embodiment, springs may be used to connect the first ramp portion 140 with the second ramp portion 150 so that the ramp 130 is biased to move to its non-extended position, to facilitate the ramp 130 locking into place when it is rotated into the closed position and preventing inadvertent opening of the ramp.

In other embodiments, other types of locking mechanisms may be used. For example, the ramp 130 may include spring-loaded hooks or tabs along the sides of the ramp 130 that can be retracted into the sides of the ramp 130 upon pressing a button or by rotating or shifting a lever, causing the ramp 130 to be disengaged from the sides of the front frame structure 120 (e.g., struts 124). Other suitable mechanisms known in the art are within the scope of the present disclosure.

In an embodiment, the front frame structure 120 is rotatably connected to the lower structure of the stroller 10, with hinges 126 connecting each strut 124 of the front frame structure 120 to an adjacent lower front leg 32 of the stroller 10. In the embodiment shown in FIGS. 1-2, the rotational axes 127 of the hinges 126 are offset from the transverse axis 123 formed by the crossbar 122. The hinges 126 may also include locking mechanisms to fix the front frame structure 120 in a particular orientation relative to the struts 124. In other embodiments, the release for the locking mechanism may be a button located on at least one of the hinges 126. In yet other embodiments, the release for the hinge's locking mechanism may be located elsewhere on the front frame structure 120 and coupled to the hinge locking mechanism, for example, as buttons at the ends of the struts 124.

The side panels 200, back panel 300 and bottom panel 400 of the basket 100 may be formed of one or more pieces of material, such as a fabric or other textile, that are shaped and sewn or bonded together to form a basket shell 102. In an embodiment, the side panels 200, back panel 300 and/or bottom panel 400 of the basket 100 may be formed of a flexible material, such as 600D polyester fabric, with the panels being attached to each other such as by sewing or other suitable means. In other embodiments the basket shell 102 may be formed of other materials that provide sufficient strength, abrasion resistance, and ease of care (e.g. easy to wash and dry, remove pet hair from, etc.). In an embodiment, the side panels and bottom panel may be formed of multiple pieces of different materials secured together. For example, as shown in the basket of FIGS. 1-5, a coated mesh fabric may be used for the front portions of the side panels 210, and a solid fabric or textile may be used for the back portions 220, with the portions attached to each other along a seam 212. The bottom panel 300 may be formed from artificial leather that is durable and allows for increased traction with a pet's feet or paws. In some aspects, one or more of the panels 200, 300, and 400 may be a rigid structure, such as a metal or plastic. For example, some aspects may include the bottom panel 300 including a plastic panel, which may further include a one or more textile components or other traction elements secured the top surface of the plastic panel. Further, in other embodiments, all panels of the basket 100 may include a rigid material.

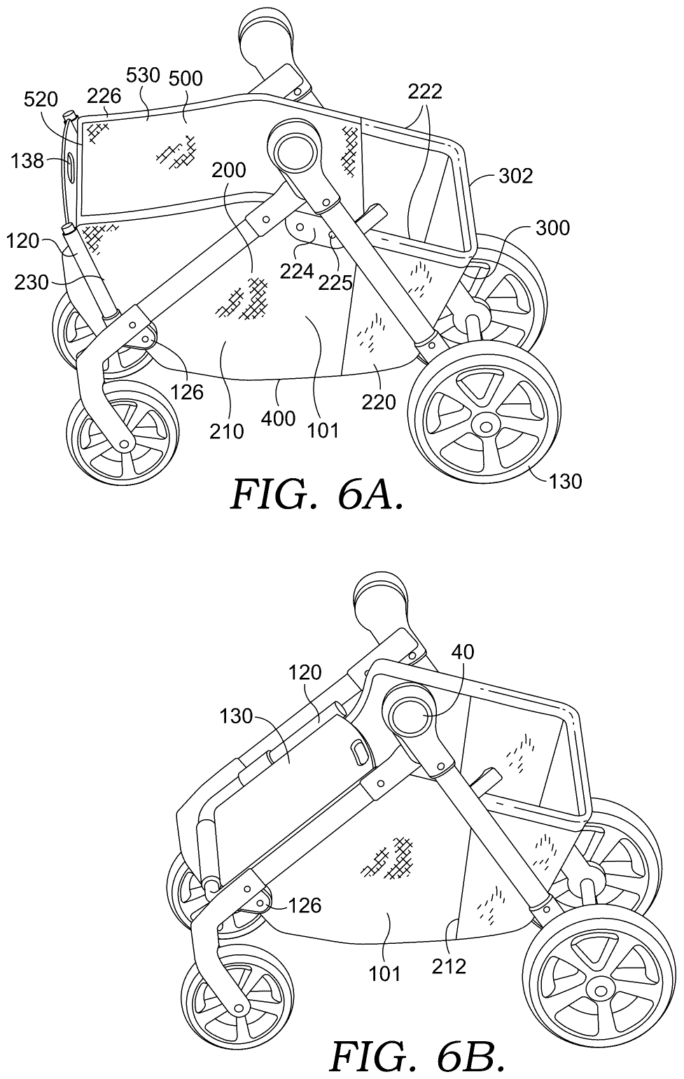

To provide additional structure and rigidity to the basket 100, the basket 100 of the embodiment shown in FIG. 1 includes a back basket frame 160 attached to the stroller 10. Looking again at FIG. 2, the back basket frame 160 is connected to both the front legs 32 and the back legs 34 of the stroller 10 with hinges 162, 164. It should be understood that the back basket frame 160 may be attached to only the front legs 32 or only the back legs 34 in other examples. As shown in FIGS. 5 and 6A-B, the top edge 302 of the back panel 300 and the top edges 222 along the portions of the side panels 200 adjacent the back panel 300 may be formed to include a tube or sleeve into which the back basket frame 160 can be inserted. The tube or sleeve is dimensioned to leave exposed the connection points on back basket frame 160 that connect at hinges 164 on the back legs 34. Additionally, flaps 224 with snap fasteners 225 (or other suitable fasteners such as hook and loop fasteners or zippers) are dimensioned to fold over the portions of the back basket frame 160 between hinge 162 and 164 on each side of the basket 200, facilitating the ability to assemble the components of the basket 100 together with each other and with the stroller 10 and to disassemble, such as for cleaning. The front edges 230 of the side panels 200 of the basket shell 102 are attached to the struts 124 of the front frame structure 120. The front edge 402 of the bottom panel 400 may be attached to the crossbar 122 of the front frame structure 120 so that it does not interfere with the rotation of the ramp 130 with the crossbar 120, using suitable fasteners or adhesives that are known in the art. In other embodiments, one or more additional rigid structures may form other parts of the frame of the basket, and may be contained within and/or connected to portions of the basket panels.

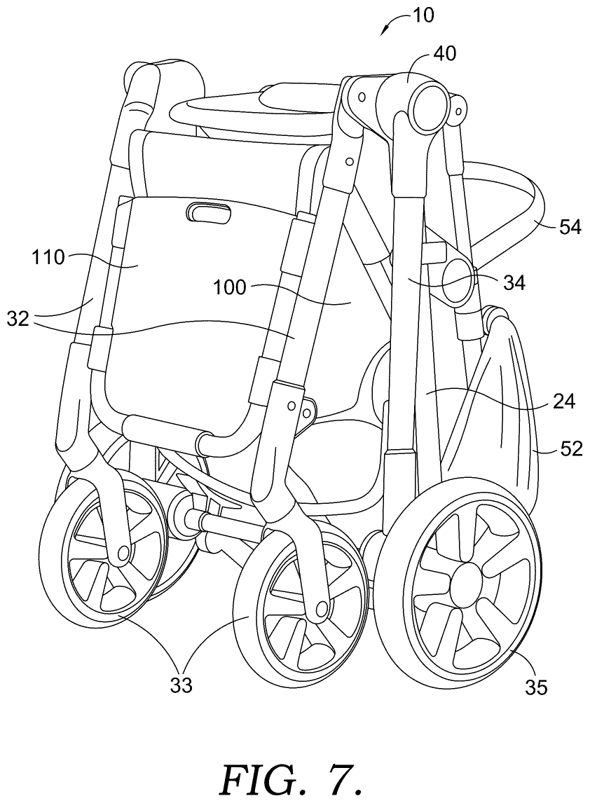

In embodiments, the components of the basket 100 are dimensioned and arranged to allow the stroller 10 to be folded into a compact or closed configuration. For example, as shown in FIG. 5 and in FIG. 7 the front frame structure 120 of the basket 100 may be rotated so that the front frame structure struts 124 and crossbar 122 are generally aligned with the plane formed by the stroller front legs 32 so that once the stroller 10 is folded, the front frame structure 120 does not significantly protrude out of the plane defined by the front legs 32. The back basket frame 160, which is able to rotate on its hinges 162, 164 can also change its orientation relative to the stroller legs 32, 34 as the stroller 10 is folded, so that it also generally remains within the plane formed by the stroller's back legs 34 when the stroller is in its folded configuration. Because the rest of the components of the basket 100, e.g., the basket shell 102 and the cover 500, are formed from flexible materials, the basket 100 can collapse accordingly within the volume between the front legs 32 and back legs 34 in the stroller's folded configuration. While the stroller shown in FIG. 7 is configured to fold in a certain manner, it is to be appreciated that the present invention may be practiced with strollers or other wheeled child carriers utilizing different folding mechanisms and configurations. The present invention may also be used on strollers or other wheeled child carrier that do not fold.

As shown in FIGS. 6A and 6B, the rotation of the front frame structure 120 from its open to its closed position changes the positioning and/or orientation of the different parts of the front frame structure 120, e.g., the struts 124 and the crossbar 122, with respect to the front legs 32 of the stroller 10. This may also result in changes the dimensions and/or orientation of the bottom panel 400 and side panels 200 of the basket 100, as well as the dimensions and volume of the basket cavity 101. This feature may be advantageous, for example, when it is desirable to have a smaller section to prevent excess movement of smaller pets or items within the section. This effect may be enhanced or minimized based on the configuration and positioning of the hinges 126 along the length of the struts 124 as well as the amount of offset of the rotational axes 127 of the hinges 126 with respect to the stroller legs 32 and/or the crossbar 122. For example, in the embodiment shown in FIGS. 5A and 5B, the rotational axes 127 of the hinges 126 is higher and further to the back of the stroller than the crossbar axis 123. When the ramp is moved from its closed position to its open position, the crossbar 122 and the bottom ends of the struts 124 move closer to the back of the stroller 10 and the tops of the struts 124 move closer to the front of the stroller 10. Because the side panels 200 and bottom panel 400 are attached the struts 124 and crossbar 122, their orientation and dimensions are accordingly affected. It is to be appreciated that the movement of the tops of the struts 124 and the crossbar 122 do not necessarily have to be oppositely correlated. For example, an embodiment in which the rotational axes 127 and the crossbar axis 123 are substantially aligned would result in little to no change in the positioning of the crossbar 122 as the front frame structure 120 moved between its open and closed positions. Embodiments are also possible where the movements of the tops of the struts 124 and the crossbar 122 are positively correlated, for example, where in a front frame structure 120 where the crossbar 122 attaches to a midpoint of the struts 124, and the struts 124 are attached to the hinges below the crossbar 122.

While the present invention has thus far been described with the ramp of the basket being positioned to face towards the front of the stroller, it is to be appreciated that the present invention may readily be used with a basket having a ramp facing towards and/or oriented in another direction, e.g., towards the back. A basket configured to have more than one ramp is also within the scope of this disclosure. As well, while the basket in the present embodiments is situated generally directly below the seat of the stroller, other positions and orientations of the seat and basket with respect to each other are also within the scope of the invention.

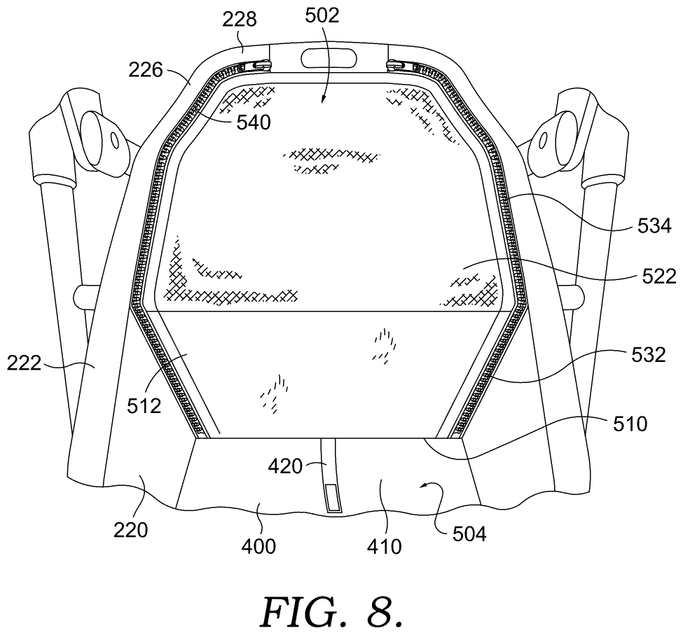

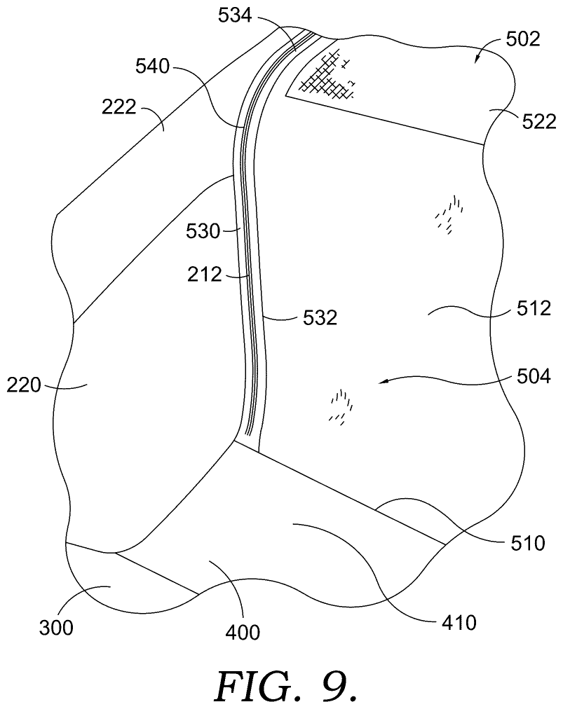

Looking now again at FIGS. 1, FIGS. 5-7 and 8-10, the basket 100 may have a cover 500 that serves to enclose a portion of the basket cavity 101. As shown in FIGS. 8 and 9, the side edges 530 of the cover 500 are connected to the side panels 200 along the respective top edges 222. Rather than connecting along the entireties of the top edges 222 of the side panels, the cover 500 extends down into the basket cavity 101. Particularly, the side edges 530 of the cover 500 are connected to the front portions 226 of the top edges 222 of the basket side panels 200 and then, at a midpoint between the front 110 of the basket 100 and the back panel 300, the cover 500 angles and extends downward towards the bottom panel 400, with the cover side edges 530 in contact with the inner surfaces of side panels 200. In the embodiment shown in FIGS. 5 and 8-10, the side panels 200 are each constructed from two pieces of material (which may be referred to as a first portion 210 of the side panel 200 and a second portion 220) joined along a seam 212, and the cover 500 angles downward into the basket cavity 101. In other example embodiments, the side panels 200 may be formed of a single seamless piece of material or more than two pieces of material.

In this way, the cover 500 has a first portion 512 that extends within the basket cavity 101 generally towards the bottom panel 400 and a second portion 522 that extends over a portion of the basket cavity 101. The first portion 512 of the cover 500 can act as a divider of the basket 100 in that in defines and at least partially separates two areas of the basket cavity 101. Meanwhile, the second portion 522 of the cover 500 defines a top wall over (i.e., covers) part of the basket cavity 101. Further, the side edges 530 of the cover 500 may each be divided, for reference purposes, into a proximal edge portion 532 adjacent the first end 510 of the cover 500 and a distal edge portion 534 adjacent the second end 520 of the cover 500, where the proximal edge portion couples to the inner surface of side panel 200, while the distal edge portion 534 couples to the top edges 222 of the side panels 200 and, optionally, a top portion of the front frame structure 220. While the embodiment shown depicts the first portion 512 of the cover 512 forming a substantially orthogonal angle with the top surface 410 of the bottom panel 400, other angles and configurations are within the scope of the present invention. For example, the cover side edges 530 may define a curve or a wave along the inside surfaces of side panels 200.

In an embodiment shown in FIGS. 8 and 9, zippers 540 are used to connect the cover 500 along the length of the cover side edges 530 to the top edges (e.g., top edges 222) and inner surfaces of side panels 200. In an embodiment, the cover side edges 530 comprise a length of zipper teeth and the other components of the zipper 540 (e.g., other zipper teeth, slider, pull, stops, etc.) are attached to the side panel components. In other embodiments, different releasable fasteners, such as snap connectors, can be used. Portions of the cover side edges 530 may also be fastened using different combinations of fasteners. For example, zippers may be used to attach the cover side edges 530 to the front portions 226 of the top edges 222 of the side panels 200, while snap connectors are used to attach the cover side edges 530 to the inner surfaces of side panels 200. Further, in exemplary embodiments, the zippers 540 are continuous at least between the first portion 512 and the second portion 522 of the cover 500. In the embodiment shown in FIGS. 8-10, the zipper 540 runs substantially along the seam 212 that connects the front portion 210 and the second portion 220 of the side panel 220 together. In other embodiments, the zipper 540 may be attached to another part of the inner surface of the side panel 200. In the embodiment of FIGS. 8-10, additional ends 228 can extend from the front portions 226 of the top edges 220 of the basket side panels 200, which, when the cover is fully zippered, hold the second end 520 of the cover 500 next to the front panel 110 of the basket.

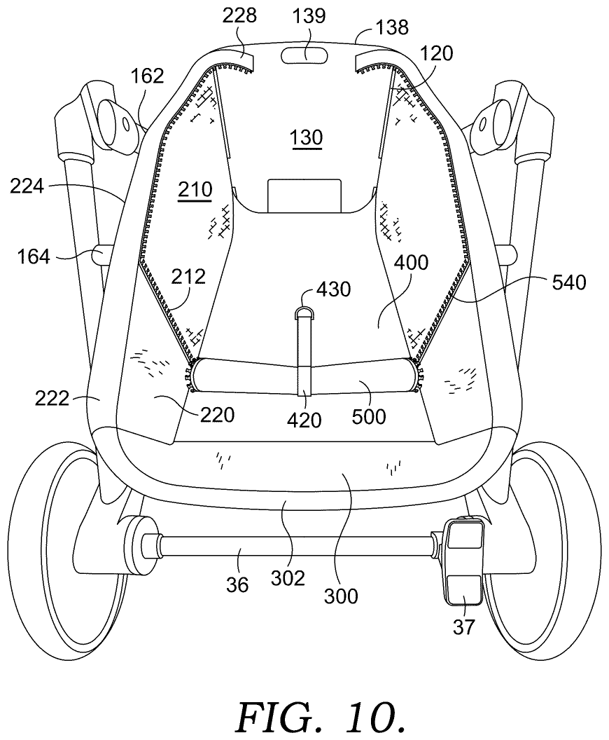

The first end 510 of the cover 500 may be attached to the top surface 410 of the basket bottom panel 400. In the embodiment shown in FIG. 10, the first end 510 is permanently attached to the top surface 410. In other embodiments, the first end 510 is releasably attached, e.g., via hook and loop fasteners, snap fasteners or other suitable releasable fasteners.

The second end 520 of the cover 500 may be releasably attached to the second end 138 of the ramp 130 when the ramp 130 is in its closed position relative to the front frame structure 120. In an embodiment, one or more magnets (not shown) may be positioned on the edge of the second end 520 of the cover 500 and plates made of a magnetic material (e.g., steel or additional magnets) can be positioned on the second end 138 of the ramp 130, providing a releasable attachment between the two. In other embodiments, an elastic and hook system can be used. It will be appreciated that other suitable fastening mechanisms or systems, such as hook and elastic, hook and loop, or snaps, are also within the scope of the present disclosure. In other aspects, the cover 500 may be releasably coupled to the top edge 302 of the back panel 300 instead of to the front 110 of the basket 100.

As seen in FIGS. 5, 8 and 9, the cover 500, when attached along the inner surfaces of side panels 200, divides the basket cavity or volume 101 into a front section 502 (which may also be referred to herein as a front compartment) and a back section 504 (which may also be referred to as a back compartment). Continuing to fasten the cover 500 to the top edges 222 of the front portion of the side panels 200 results in the top of the front section 502 being fully enclosed by the basket front 110, the front portions 212 of the side panels 200, a front portion of the bottom panel 400 and the cover 500, with the first portion of the cover 512 forming the back of the front section 502 and the second portion of the cover 500 forming the top of the front section 502. While the front section 502 of the basket cavity 101 may be covered by the cover 500, the back section 504 may remain uncovered.

When the zippers 540 are connected only along the inner surfaces of the side panels 200, the cover 500 still acts as a divider between the front section 502 and the back section 504. The unattached portion of the cover 500 may be rolled up or folded and secured out of the way. For example, magnetic plates may also be inserted in or near to the first end 510 of the cover 500 so that the magnets in the second end 520 can be releasably attached and hold against or next to the first end 510 of the cover 500 when the cover 500 is folded over itself.

When the zippers 540 along the cover side edges 530 are fully unzipped, the cover 500 can be stored away. As shown in FIG. 10, in an embodiment where the first end 510 of the cover 500 is permanently attached to the top surface of the bottom panel 400, the cover 500 may be rolled up and secured to the bottom panel 400 by a releasable strap or tab 420. In another embodiment, when the first end 510 of the cover 500 is releasably attached to the bottom panel 400, the cover 500 may be rolled up or folded and stored away in a pocket or storage section (not shown) located on the basket 100 or elsewhere on the stroller 10.

In other embodiments, the cover 500 may be configured so that in addition to being able to sectionalize and cover only the front section 502 of the basket cavity 101, the cover side edges 530 of the cover 500 can alternatively be attached along the entirety of the top edges 222 of the basket side panels 200 and the first end 510 can be attached to the top edge 302 of the back panel 300, so that the entire basket cavity 101 is enclosed. It is readily seen that a cover 500 practicing this aspect of the invention allows for multiple configurations and use cases for the basket 100. Furthermore, while the embodiment of FIG. 8-10 have the cover 530 being configured to be attachable over the top of the front section 502 of the basket cavity 101, other embodiments may have the cover 500 being configured to be attachable over the top of the back section 504, e.g., having the distal edge portions 534 attached to the portions of the side panel top edges 222 adjacent to the back panel 300, and with the second end 520 of the cover 500 being attachable to the top edge of the back panel 300.

As with the basket shell 102, the cover 500 may be formed from one piece of material or may be composed of multiple parts using different materials. For example, the cover 500 shown in FIG. 1 comprises the first portion 512 made of a solid fabric and the second portion 522 made of a mesh fabric with the portions being joined together along their respective interior edges. The first portion 512 corresponds to the part of the cover 500 that acts as the divider between the front section 502 and the back section 504, and the second portion 522 of the cover 500 corresponds to the part of the cover 500 that encloses the top of the front section 502. As shown in FIG. 1, this results in an enclosed front section 502 with multiple ventilated sides and a back section 504 having solid sides and an open top. It is to be appreciated that other configurations and dimensioning can be made for additional reasons, such as aesthetics, durability, availability and cost.

The basket 100, including the frame and materials described herein, may be selected and designed to meet basic minimum standards or requirements for pet usage. For example, in certain aspects, the basket 100 is able to hold a minimum weight of 35 pounds (approximately 15.9 kilograms) and provide sufficient breathability and airflow even when the cover 500 fully encloses the front section. Other enhancements to the basket 100, cover 500, or stroller 10 may also be made to increase its usability for pet owners. For example, as shown in FIG. 10, a D-ring 430 or similar attachment point to tether a pet to may be provided on the stroller frame or in the basket 100.

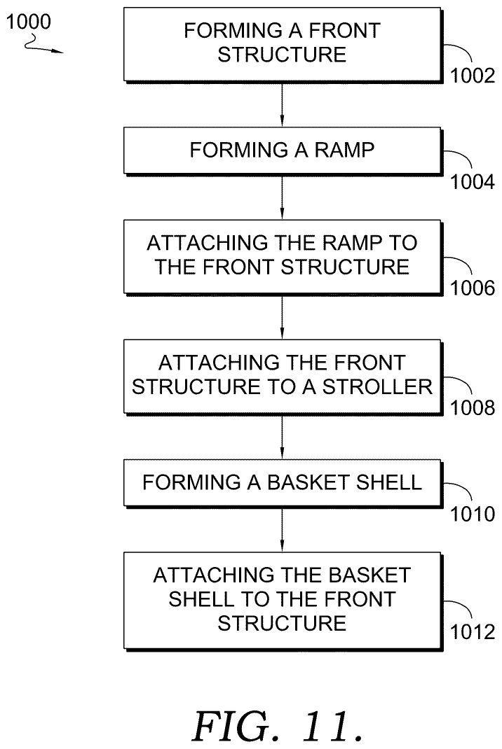

Looking now at FIG. 11, a block diagram of a method 1000 of manufacturing a basket in accordance with embodiments of the present disclosure is provided. The method 1000 includes blocks 1002-1008, but is not limited to this selection of elements, or the order depicted. In block 1002, the method 1000 includes forming, e.g., using one or more component manufacturing or assembly methods described herein, a front frame structure, e.g., such as the front frame structure 120 shown in FIG. 1. In block 1004, the method 1000 includes forming, e.g., using one or more component manufacturing or assembly methods described herein, a ramp, e.g., the ramp 130 shown in FIGS. 1-3. In block 1006, the method 1000 includes attaching the ramp to the front frame structure. In block 1008, the method 1000 includes attaching front frame structure to the stroller, e.g., attaching the front frame structure 120 via hinges 126 to the front legs 34 of stroller 100. In block 1010, the method 1000 includes forming, e.g., using one or more component manufacturing or assembly methods described herein, a basket shell, e.g., such as the basket shell 102 describe herein comprising side panels 200, back panel 300 and bottom panel 400. In block 1012, the method 1000 includes assembling, e.g., using one or more component manufacturing or assembly methods described herein, the basket shell with the front frame structure. The method 1000 can further include one or more of the following steps: forming additional basket structural elements, e.g., such as the back basket frame 160 as shown in FIG. 2; installing the additional basket structural elements to the stroller, e.g., such as installing the back basket frame 160 to the stroller legs 32, 34, via hinges 162, 164; and fastening the basket shell to the additional basket structural elements, e.g., such as connecting the basket shell 102 to the back basket frame 160 by inserting the back basket frame 160 into a sleeve along the top edges of the side panels 200 and back panel 300 as shown in FIG. 6A. Additionally, and in separate steps, flaps 224 can be fastened around the back basket frame 160, as shown in FIG. 6A, and a cover can be connected to the basket, such as the cover 500 described herein.

Although aspects of the stroller 10, basket 100, cover 500 and components thereof are generally described with respect to benefits for transporting a pet, it should be understood that aspects of this disclosure should not be limited to the use of transporting pets or animals. Rather, it will be appreciated that aspects of the disclosure, such as the cover 500 for example, may be useful and desirable in other use cases.

Clause 1. A basket for a wheeled child carrier comprising: a front panel, the front panel comprising a front frame structure and a ramp, the ramp comprising a first end rotatably attached to the front frame structure; wherein the ramp is rotatable between a closed position and an open position relative to the front frame structure; and the front frame structure is rotatably attached to a lower structure of the wheeled child carrier, the front frame structure being rotatable between a first position and a second position relative to the lower structure.

Clause 2. The basket of clause 1, wherein the front frame structure further comprises a first strut, a second strut, and a crossbar connecting the first strut and the second strut.

Clause 3. The basket of clause 1 or 2, wherein the first end of the ramp is rotatably attached to the crossbar.

Clause 4. The basket of any of clauses 1-3, wherein the crossbar changes its position relative to lower structure of the wheeled child carrier when the front frame structure moves between the first position and the second position.

Clause 5. The basket of any of clauses 1-4, wherein the ramp further comprises a first panel and a second panel being slidably attached to each other, the first end of the ramp being formed by the first panel and a second end of the ramp being formed by the second panel.

Clause 6. The basket of any of clauses 1-5, wherein the front panel further comprises a locking mechanism capable of locking the ramp to the front frame structure in the closed position.

Clause 7. The basket of any of clauses 1-6, the basket further comprising a bottom, a first side panel, a second side panel and a back panel, wherein the bottom is connected to the first side panel, the second side panel, the back panel, and the front frame structure; the first side panel is connected to the back panel and the front frame structure; and the second side panel is connected to the back panel and the second strut structure.

Clause 8. The basket of any of clauses 1-7, wherein the first side panel and the second side panel each undergo a change in at least one dimension or orientation when the front frame structure moves between the first position and the second position.

Clause 9. The basket of any of clauses 1-8, further comprising a locking mechanism capable of locking the front frame structure in the first position relative to the lower structure of the wheeled child carrier.

Clause 10. A method of manufacturing a basket for a wheeled child carrier, comprising the steps of forming a front panel, the front panel comprising a front frame structure and a ramp, the ramp comprising a first end rotatably attached to the front frame structure; connecting the front panel to a first side panel, a second side panel, and a bottom panel; connecting the first side panel, the second side panel, and the bottom panel to a back panel; and connecting the basket body to the wheeled child carrier, wherein the front frame structure is rotatably relative to a lower end of the wheeled child carrier, wherein the front panel, the first side panel, the second side panel, the bottom panel and the back panel defining a basket cavity; and the ramp is rotatable between a closed position and an open position relative to the front frame structure.

Clause 11. The method of clause 10, wherein the step of connecting the front panel to form a basket body further comprises the steps of connecting a first side of the front frame structure to a front edge of the first side panel; connecting a second side of the front frame structure to a front edge of the second side panel; and connecting a bottom of the front frame structure to a front edge of the bottom panel.

Clause 12. The method of clause 10 or 11, wherein the first side of the front frame structure comprises a first strut, the second side of the front frame structure comprises a second strut, and the bottom of the front frame structure comprises a crossbar connecting the first strut and the second strut.

Clause 13. The method any of clauses 10-12, wherein the first end of the ramp is rotatably attached to the crossbar.

Clause 14. The method of any of clauses 10-13, wherein the ramp comprises a first panel and a second panel being slidably attached to each other, the first end of the ramp being formed by the first panel and a second end of the ramp being formed by the second panel.

Clause 15. The method of any of clauses 10-14, wherein the ramp comprises at least one panel having a plurality of openings.

Clause 16. A wheeled child carrier for transporting a child and a pet simultaneously, comprising a wheeled child carrier frame; a seat connected to the frame and configured to secure a child; and a basket connected to the lower structure, the basket comprising a cavity and a ramp that can move between a closed position and an open position, the ramp configured to provide a surface for the pet to walk on when in an open position and to enclose the pet within the cavity when in a closed position.

Clause 17. The wheeled child carrier of clause 16, wherein the basket further comprises a front frame structure, wherein the ramp is rotatably connected to the front frame structure and the front frame structure is rotatably connected to the wheeled child carrier frame between an open position and a closed position.

Clause 18. The wheeled child carrier of clauses 16 or 17, wherein at least one dimension of the basket cavity is changed when the front frame structure is moved from the open position to the closed position.

Clause 19. The wheeled child carrier of any of clauses 16-18, wherein the wheeled child carrier frame is capable of collapsing into a folded position, and wherein the basket volume is less than the second volume when the wheeled child carrier frame is in the folded position.

Clause 20. The wheeled child carrier of any of clauses 16-19, wherein the wheeled child carrier is a stroller and the basket is positioned below the seat.

Clause 21. A basket for a wheeled child carrier, comprising: a plurality of side panels connected to each other and to a bottom panel, the plurality of side panels and the bottom panel defining a cavity, each of the plurality of side panels comprising a top edge, a bottom edge, and an inner surface facing the cavity; the bottom panel comprising a top surface facing the cavity, the plurality of side panels including a first side panel and a second side panel; and a cover comprising a first end, a second end, and a first edge and a second edge, each of the first edge and the second edge extending between the first end and the second end; each of the first edge and the second edge of the cover having a proximal edge portion and a distal edge portion, the proximal edge portions being adjacent to the first end of the cover and the distal edges being adjacent to the second end of the cover; wherein the proximal edge portion of the first edge is releasably attached to the inner surface of the first side panel and the distal edge portion of the first edge is releasably connected to the top edge of the first side panel, and the proximal edge portion of the second edge is releasably connected to the inner surface of the second side panel, and the distal edge portion of the second edge is releasably connected to the top edge of the second side panel.

Clause 22. The basket of clause 21, wherein the proximal edge portion of the first edge and the distal edge portion of the first edge are releasably connected to the inner surface of the first side panel by a continuous zipper.

Clause 23. The basket of clause 21 or 22, wherein the zipper comprises a slide, and the zipper detaches when the slide moves in a direction from the second end of the cover to the first end of the cover.

Clause 24. The basket of any of clauses 21-23, wherein the first end of the cover is adjacent and not directly attached to the bottom panel.

Clause 25. The basket of any of clauses 21-24, wherein the first end of the cover is attached to the top surface of the bottom panel.

Clause 26. The basket of any of clauses 21-25, wherein when the first and second proximal edges are connected to the inner surfaces of the first side panel and second side panel respectively, the cover defines a first section and a second section within the cavity.

Clause 27. The basket of any of clauses 21-26, wherein when the first and second distal edges are connected to the first and second top edges respectively, the cover covers at least a portion of the first section of the cavity.

Clause 28. The basket of any of clauses 21-27, wherein at least a portion of the first proximal edge and the second proximal edge, when connected to inner surfaces of the first side panel and second side panel respectively, are approximately orthogonal to the bottom panel at the point where the front end of the cover is attached to the bottom panel.

Clause 29. A cover for a basket having a first and second side panels, each first and second side panel having a top edge and an inner surface, the cover comprising: a body formed of flexible material and comprising a first end, a second end opposite the first end, a first side edge running between the first end and the second end, and a second side edge running between the first end and the second edge and opposite the first side edge; wherein the first side edge and the second side edge are configured to be releasably connected to the top edges and inner surfaces of each of the first and second side panels.

Clause 30. The cover of clause 29, wherein the body comprises a first section having a first interior edge and a second section have a second interior edge joined to the first edge.

Clause 31. The cover of clause 29 or 30, wherein first section and the second section are formed of different materials.

Clause 32. The cover of any of clauses 29-31, wherein first section and the second section are formed of different materials.

Clause 33. The cover of any of clauses 29-32, wherein the first side edge and the second side edge further comprise zipper teeth.

Clause 34. A method for dividing a basket cavity of basket into a first compartment and a second compartment, the basket comprising a front panel, a first side panel, a second side panel, a back panel, and a bottom panel, the basket further comprising a cover having a first end attached to the bottom panel, a second end opposite the first end, a first side edge, and second side edge, the method comprising the steps of: attaching a first portion of the first side edge of the cover along an inner surface of the first side panel; attaching a second portion of the first side edge of the cover along a top edge of the first side panel; attaching a first portion of the second side edge of the cover along an inner surface of the second side panel; and attaching a second portion of the second side edge of the cover to a portion of a top edge of the second panel.

Clause 35. The method of clause 34, wherein at least part of the cover comprises a mesh material.

Clause 36. The method of clause 34 or 35, further comprising the step of attaching the second end of the cover to the front panel.

Clause 37. The method of any of clauses 34-36, further comprising the steps of attaching the second end of the cover to the first end of the cover when the first side edge and the second side edge are unattached to first and second side panels.

Clause 38. The method of any of clauses 34-37, further comprising the step of attaching the second end of the cover to the bottom panel.

Clause 39. The method of any of clauses 34-38, wherein the attaching steps comprise using zippers.

Clause 40. The method of any of clauses 34-39, wherein the step of attaching the second end of the cover to the front panel comprises using magnets.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

This above detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof.

What is claimed is:

1. A basket for a wheeled child carrier comprising:
a front panel, the front panel comprising a front frame structure and a ramp, the ramp comprising a first end rotatably attached to the front frame structure;
wherein the ramp is rotatable between a closed position and an open position relative to the front frame structure; and the front frame structure is rotatably attached to a lower structure of the wheeled child carrier, the front frame structure being rotatable between a first position and a second position relative to the lower structure.

2. The basket of claim 1, wherein the front frame structure further comprises a first strut, a second strut, and a crossbar connecting the first strut and the second strut.

3. The basket of claim 2, wherein the first end of the ramp is rotatably attached to the crossbar.

4. The basket of claim 2, wherein the crossbar changes its position relative to lower structure of the wheeled child carrier when the front frame structure moves between the first position and the second position.

5. The basket of claim 1, wherein the ramp further comprises a first panel and a second panel being slidably attached to each other, the first end of the ramp being formed by the first panel and a second end of the ramp being formed by the second panel.

6. The basket of claim 5, wherein the front panel further comprises a locking mechanism capable of locking the ramp to the front frame structure in the closed position.

7. The basket of claim 1, the basket further comprising a bottom, a first side panel, a second side panel and a back panel, wherein:
the bottom is connected to the first side panel, the second side panel, the back panel, and the front frame structure;
the first side panel is connected to the back panel and the front frame structure; and
the second side panel is connected to the back panel and the second strut structure.

8. The basket of claim 7, wherein the first side panel and the second side panel each undergo a change in at least one dimension or orientation when the front frame structure moves between the first position and the second position.

9. The basket of claim 1, further comprising a locking mechanism capable of locking the front frame structure in the first position relative to the lower structure of the wheeled child carrier.

10. A method of manufacturing a basket for a wheeled child carrier, comprising the steps of:
forming a front panel, the front panel comprising a front frame structure and a ramp, the ramp comprising a first end rotatably attached to the front frame structure;
connecting the front panel to a first side panel, a second side panel, and a bottom panel;
connecting the first side panel, the second side panel, and the bottom panel to a back panel; and
connecting the basket body to the wheeled child carrier, wherein the front frame structure is rotatably relative to a lower end of the wheeled child carrier,
wherein the front panel, the first side panel, the second side panel, the bottom panel and the back panel defining a basket cavity; and the ramp is rotatable between a closed position and an open position relative to the front frame structure.

11. The method of claim 10, wherein the step of connecting the front panel to form a basket body further comprises the steps of:
connecting a first side of the front frame structure to a front edge of the first side panel;
connecting a second side of the front frame structure to a front edge of the second side panel; and
connecting a bottom of the front frame structure to a front edge of the bottom panel.

12. The method of claim 11, wherein the first side of the front frame structure comprises a first strut, the second side of the front frame structure comprises a second strut, and the bottom of the front frame structure comprises a crossbar connecting the first strut and the second strut.

13. The method of claim 12, wherein the first end of the ramp is rotatably attached to the crossbar.

14. The method of claim 10, wherein the ramp comprises a first panel and a second panel being slidably attached to each other, the first end of the ramp being formed by the first panel and a second end of the ramp being formed by the second panel.

15. The method of claim 10, wherein the ramp comprises at least one panel having a plurality of openings.

16. A wheeled child carrier for transporting a child and a pet simultaneously, comprising:
a wheeled child carrier frame;
a seat connected to the frame and configured to secure a child; and
a basket connected to the lower structure, the basket comprising a cavity and a ramp that can move between a closed position and an open position, the ramp configured to provide a surface for the pet to walk on when in an open position and to enclose the pet within the cavity when in a closed position.

17. The wheeled child carrier of claim 16, wherein the basket further comprises a front frame structure, wherein the ramp is rotatably connected to the front frame structure and the front frame structure is rotatably connected to the wheeled child carrier frame between an open position and a closed position.

18. The wheeled child carrier of claim 17, wherein at least one dimension of the basket cavity is changed when the front frame structure is moved from the open position to the closed position.

19. The wheeled child carrier of claim 18, wherein the wheeled child carrier frame is capable of collapsing into a folded position, and wherein the basket volume is less than the second volume when the wheeled child carrier frame is in the folded position.

20. The wheeled child carrier of claim 17, wherein the wheeled child carrier is a stroller and the basket is positioned below the seat.
